(19) United States
(12) Patent Application Publication
(10) Pub. No.: US 2014/0083369 A1
(43) Pub. Date: Mar. 27, 2014

(54) Equine safety sling for supporting a horse during transportation

(71) Applicant: Barbara Diane Marks, Torrance, CA (US)

(72) Inventor: Barbara Diane Marks, Torrance, CA (US)

(21) Appl. No.: 13/628,004

(22) Filed: Sep. 26, 2012

(51) Int. Cl. A01K 15/04

(52) U.S. Cl. 119/725

(57) ABSTRACT

An equine safety sling for supporting a horse or other animal during transportation includes first and second outer straps, each outer strap having a front and rear end, thereby providing four ends; a front inner strap that connects the outer straps so that the device supports the animal behind the front legs of the animal; a rear inner strap that connects the outer straps so that the device supports the animal in front of the rear legs of the animal; and a main loop at each of the four ends of the outer straps, adapted so that the device can be retained utilizing the main loops so as to secure the animal in place. A sliding pin bracket may retain the sling to the inside of a trailer and allow the horse to be quickly released.

### BACKGROUND OF THE INVENTION

The present invention generally relates to transporting animals and more specifically to an equine safety sling for supporting a horse during transportation.

Existing systems have cameras in a horse trailer. These are reactive devices, which tell you that the horse has already fallen. Existing equine sling systems have an entire device that is part of the trailer.

It would be desirable to have a sling for a horse trailer that retains and supports the horse to help prevent the horse from being injured.

### SUMMARY OF THE INVENTION

In one aspect of the present invention, a device for an animal having front and rear legs includes first and second outer straps, each outer strap having a front and rear end, thereby providing four ends; a front inner strap that connects the outer straps so that the device supports the animal behind the front legs of the animal; a rear inner strap that connects the outer straps so that the device supports the animal in front of the rear legs of the animal; and a main loop at each of the four ends of the outer straps, adapted so that the device can be retained utilizing the main loops so as to secure the animal in place.

In another aspect of the present invention, a system to retain an animal includes a sling for the animal, having inner and outer straps that form an “H” shape, the sling having a loop at each of the outer four ends of the “H”; and a plurality of retaining elements that engage with the loops so as to releasably retain the sling, thereby retaining the animal.

In yet another aspect of the present invention, a method of supporting an animal during transportation includes providing a sling that includes two outer straps and two inner straps that connect the outer straps to form an enclosed H, the outer straps having a main loop at each of the four ends of the outer straps; providing a trailer that includes four retaining elements; loading the animal into the trailer; attaching the main loops to the retaining elements so as to retain the animal in the trailer; and transporting the animal; wherein the sling supports the animal so as to help prevent the animal from falling during transportation.

### BRIEF DESCRIPTION OF THE DRAWINGS

FIG. 1 is a perspective view of an embodiment of a system according to the present invention;

FIG. 2 is a section view of the embodiment of FIG. 1 taken along line 2-2 of FIG. 1;

FIG. 3 is a top view of an embodiment of a sling according to the present invention;

FIG. 4 is a front view of the embodiment of FIG. 3;

FIG. 5 is a side view of the embodiment of FIG. 3;

FIG. 6 is a section view of the embodiment of FIG. 3 taken along line 6-6 in FIG. 5;

FIG. 7 is a side view of an embodiment of a sliding pin bracket system according to the present invention; and

FIG. 8 is a perspective view of an embodiment of a sliding pin bracket system with two sliding pins in use with a sling according to the present invention.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

The present invention relates to an equine safety sling for supporting a horse during transportation. Embodiments of the present invention may reduce the risk of injury during the transport of an animal. Embodiments of this invention may help to stabilize a horse in case of a fall or slip. The horse may fall into the sling and be able to regain its footing.

Embodiments of an equine safety sling may include nylon woven straps sewn into an enclosed “H” design. Example embodiments of a nylon design may include nylon rated for 9,600 pounds of weight in a basket position. Embodiments may have four main loops and four auxiliary loops at the corners of the enclosed “H” design. Main loops may provide the main support to attach the sling to the trailer, and auxiliary loops may be used in auxiliary functions at the same time, such as to further retain or maneuver the horse. The sling may have 2 outer straps, which are long and have loops at the ends, and 2 shorter, inner (near the center) support straps that connect between the outer straps. The 2 outer straps may be generally parallel, and the 2 inner supports straps generally perpendicular to the outer straps, thereby forming an “H” shaped sling. The shape is an “H” because the two outer straps form the outer sides of the H, and the two inner straps form the horizontal line of the H. The sling has a front inner strap that supports the horse just behind the horse's front legs, and a similar rear inner strap that supports the horse just in front of the horse's rear legs, so that the sling comfortably can support the horse. The sling may have loops on ends of the outer straps that slide over a sliding pin bracket system or other mounting posts or mounting system in the trailer to hold the sling in place within the trailer. Instead of having permanently attached auxiliary loops, embodiments may have apertures in the outer straps that allow auxiliary straps with the auxiliary loops to be secured to the apertures and then removed when not needed.

Embodiment of the invention may include an equine safety sling that slides into four permanently flush mounted bracket systems with removable and adjustable pins in a horse trailer that when put into place underneath the horse's stomach support the horse in case of slippage or fall during transportation. Examples of a bracket system may, for example, include stabilizing pins, which may be flush mounted to the interior sides of the trailer or otherwise mounted to help retain the sling to support the horse.

An embodiment of an equine safety sling may be stored on the wall of the trailer hanging from two loops. Once the horse is in position the hauler can reach under the stomach of the horse and attach the remaining two loops equine safety sling into the bracket. These loops may slide into stabilizing pins inside the trailer.

The structure of an embodiment of an equine safety sling could be enlarged to encompass the front and rear portion of the animal. This could include adjustable straps that can be shortened or lengthened when not in use. The enlargement could prevent the horse from uneven weight distribution during travel.

Embodiments of a sling could be used to transport other types of large bred animals. Embodiments could be used to transport sick, pregnant, or injured animals.

Embodiments may be supported with a cross-weave at 4 points, which are placed in adjustable brackets on the inside of the trailer. If the horse slips during transport, the sling may help catch the horse and prevent falls and subsequent injuries.

In an embodiment of the invention, upon arrival at the new location, if the animal is unable to stand on its own, the auxiliary loops could act as additional safety loops that are accessible by travois poles. The animal can then be extracted from the trailer by either human intervention or mechanical equipment. When not in use, embodiments of a sling could be folded up and stored or kept in a pocket.

An embodiment of a trailer interior may have a flush adjustable slide pin bracket system used to secure the sling to the trailer. The brackets and the adjustable pin system may allow the sling to be used on various horse heights, and to alleviate the need for different sizes of slings. The pins may be secured in the bracket by pin and ring that snaps open and shut, a cotter pin, or another pin retaining element so the pins cannot accidently come out during use. After releasing the pin retaining element, the pins may be removed under pressure by horizontal extraction which will remove the sling, freeing the animal. A retaining plate on the pin may be inside of or adjacent to the handle, so that the user can hold the handle and push the pin into a first aperture in a first beam.

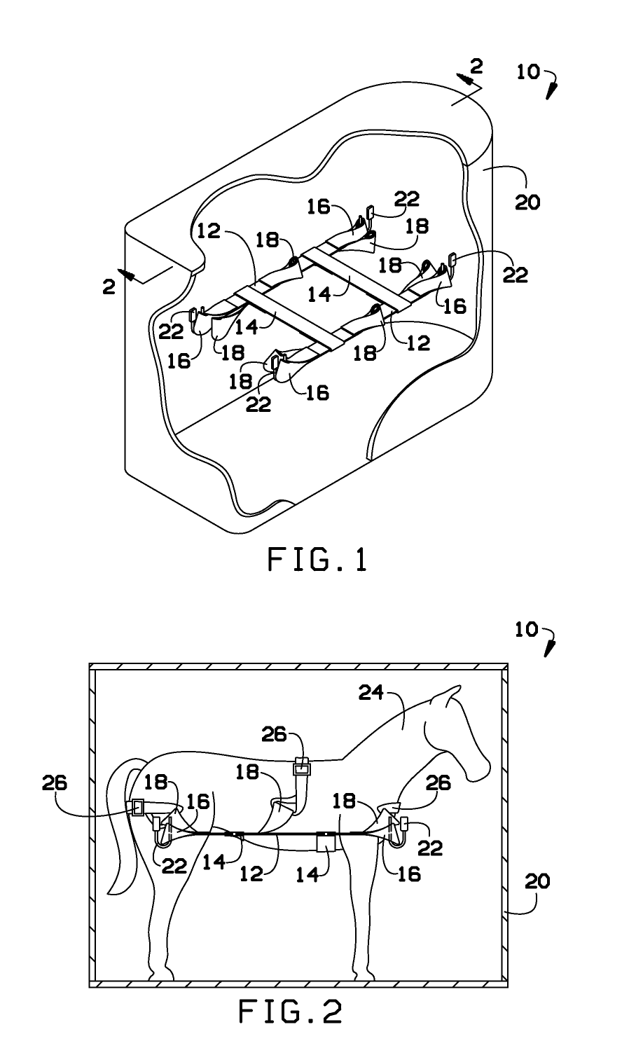

FIG. 1 depicts an embodiment of an equine safety sling 10 positioned in a trailer 20. Sling 10 could be secured directly under the mid section of the animal. Sling 10 may be positioned just below the mid section of the animal to be transported with one inner support strap 14 behind the front legs of the animal and another inner support strap 14 in front of the back legs thus creating a safety net. Two outer straps 12 may be attached to two inner support straps 14. Four main loops 16 may be included at the ends of the outers straps 12, for securing the sling to the trailer 20. Each main loop 16 may slide over a flush mount slide pins 22 or other mounting posts in the trailer 20. For additional stability, auxiliary loops 18 may be attached to the animal by an optional belt system. Embodiments may include 6 auxiliary loops along the outer straps: 2 front, 2 mid section between the inner support straps 14 in the rear. The loops 16 and 18 may part of the outer straps, may be fixed to the outer straps for example by sewing or gluing, or may removably attached to the outer straps by an adjustable and removable strap with a buckle closure. Auxiliary loops 18 may offer additional stability for the animal and options for the owner/operator. If the animal falls during transport and is unable to regain footing the additional loops can be used to lift the animal. Auxiliary loops 18 may also be used in conjunction with a belt to further limit the animal's forward, backward and vertical mobility. Embodiments may not be included with the auxiliary loops 18, but may have attachments such as slots or grooves to attach auxiliary loops when needed.

FIG. 2 depicts an example usage of an embodiment of a sling 10 inside a trailer 20. Sling 10 may be secured by flush mount pins 22 or other posts or brackets inside the trailer. Auxiliary loops 18 may be available to attach optional additional positioning restraints 26. Auxiliary loops 18 may provide the owner additional restraint of the animal by limiting the forward, backward and vertical movement. By attaching a belt system 26 thru the auxiliary loops 18 in the front or rear, forward and backward mobility may be restricted and controlled by the tightness of the belt by the owner. A center pair of auxiliary loops 18, located between the inner support straps 14, may provide vertical support and containment by going over the back of the animal, which is fastened by belt system 26. Main loops 16 may secure the sling 10 to the trailer by placing the loop into a flush mounted bracket system and securing it with a pin 22 or other attachment for the loops.

Inner support straps 14 may be located directly under the mid section of the animal. The outside loops 16 and 18 may be secured over permanent flush mount hooks in the trailer. The sling could already be in position hanging from 2 brackets prior to loading the animal. Once the animal is loaded the operator could then retrieves the sling from under the animal and continues to secure the sling over the last 2 remaining brackets.

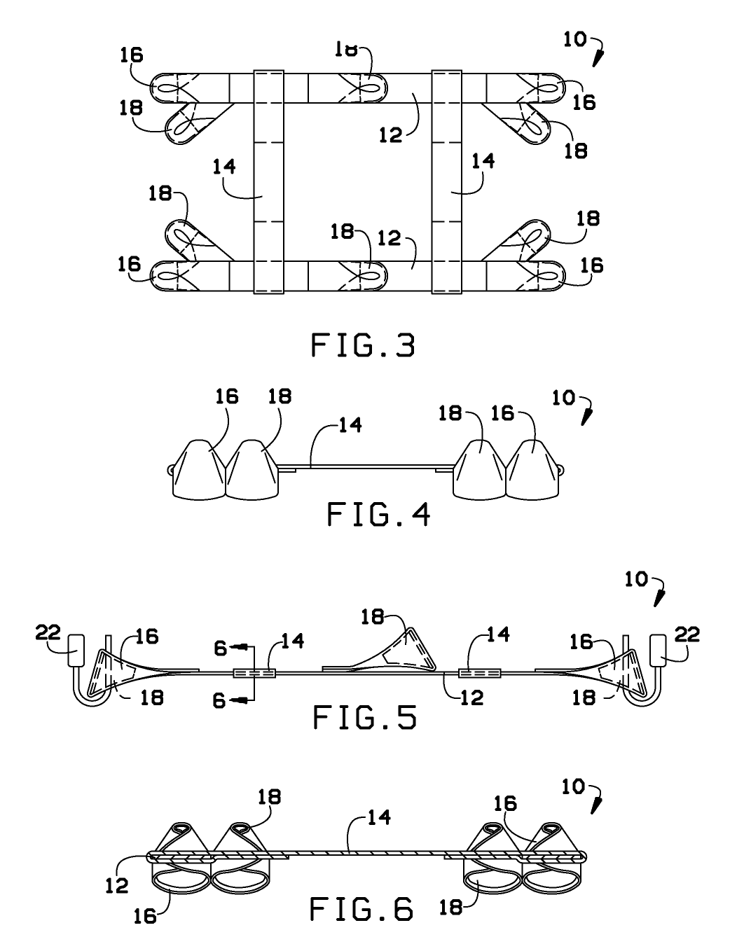

FIGS. 3, 4, 5 and 6 depict an embodiment of a sling 10. The outer straps 12 and inner support straps 14 may form the basic “H” system design. The straps may be connected together and sewn at the edges. In an embodiment, the straps may additionally be secured by an “X” through the center. Loops 16 may be utilized for stabilizing the sling 10 to a trailer, and auxiliary loops 18 may be utilized to further retain or and support the horse.

In an exemplary embodiment, outer straps 12 may be approximately 37 inches long (such as 34 inches to 40 inches) and approximately 2 inches wide. Example inner support straps 14 may be approximately 23 inches long (such as 21 inches to 27 inches) and also approximately 3 inches wide. Example sizes may be suitable for an average size horse of 1000 pounds. Slide mount sliding pin system may be adjusted to accommodate different size horses. The loops 16 and 18 may be approximately 11 inches long and can either have a 1½ nylon loop or a flat delta ring with a working load of 3,333 pounds and breaking strength of 10,000 pounds. Embodiments may be hitched differently. An example sling with these dimensions might support up to 3,800 pounds in a choker position, 4,800 pounds in a vertical position and 9,600 pounds in a basket position.

FIG. 6 depicts the attachment of the inner and outer straps. The straps may be connected together and sewn at the edges and then additionally secured by an “X” or “W” sewn where the straps overlap, to help reinforce the strength of the loops or delta ring attached to the straps. The fabric may be doubled over and then an additional material may be placed within the loop for strength. Materials used may include commercial quality polyester rated at 12,000 lb. total tensile strength which should exceed the weight requirement of an average horse. Embodiments of the fabric may include a safety core red yam, which may become exposed with eventual usage and wear, indicating to the owner operator to replace the product when this appears. The loops may be sewn closed with the additional material attached. If delta rings are used, embodiments could be rated at 10,000 lbs, with a safe working load of 3,300 lbs.

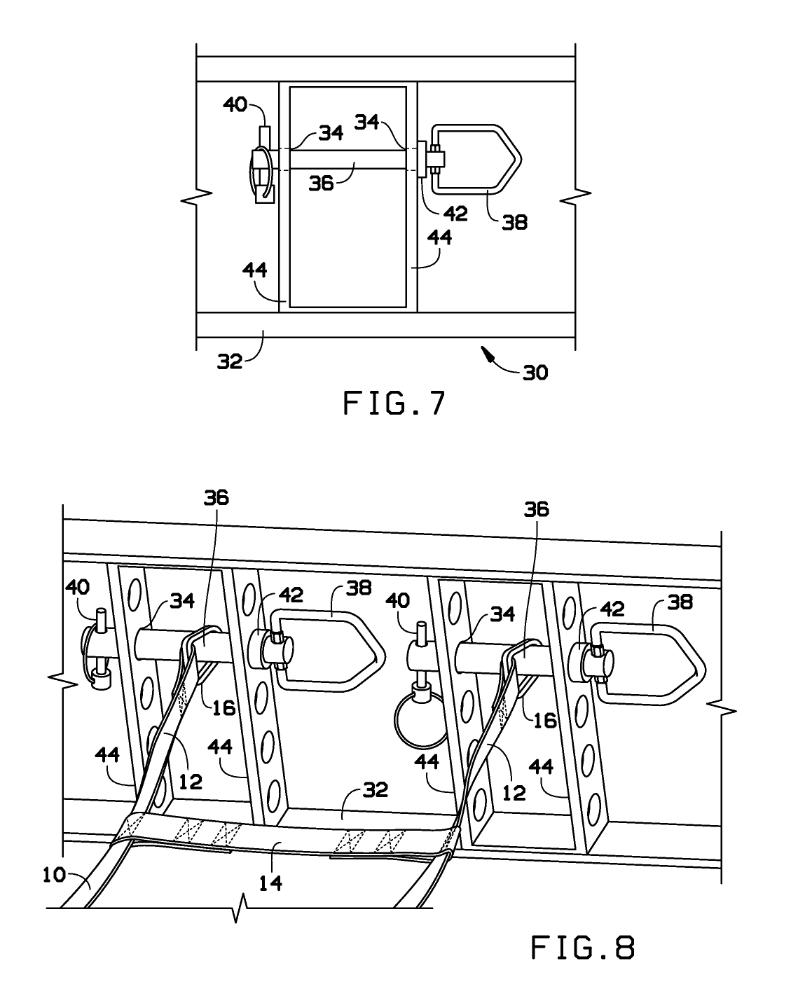

FIG. 7 depicts an embodiment of a sliding pin bracket system 30. An embodiment of a trailer interior may have a mounting system that includes four sliding pin bracket systems 30, flush with the sides of the trailer. An embodiment of a bracket system 30 may include a bracket 32 with two beams 44 having apertures 34, and a sliding pin 36 that slides through the apertures 34. Sliding pin 36 may have a handle 38 and a retaining plate 42 at one end, and a pin retaining element 40 at the opposite end so that the retaining plate 42 and pin retaining element 40 cooperate to keep the sliding pin 36 from sliding out of the bracket 32 when in use. Pin retaining element 40 may include a pin on a ring that open and snaps into a lock position. Embodiments for a two-horse trailer may include a wall or rail inside the trailer to separate the horses, with additional pin bracket systems on the internal wall so that both horses will have two pin bracket systems on each side to support a sling.

FIG. 8 depicts an embodiment of sliding pin bracket system 30 with two sliding pins 36 in use with a sling 10. Each sliding pin 36 retains a main loop 16 of the sling 10. Embodiments of a sling 10 may have outer straps 12, a center support strap 14, and main loops 16. The sliding pin bracket system 30 may have one or more brackets 32—for example, a two-horse trailer could have a long bracket 32 running lengthwise like a rail or wall between the horses, or a three-horse trailer could have two rails, possibly at a diagonal angle relative to the trailer, to create 3 compartments to separate 3 horses. One side of a sling could attach to a rail, and the other side could attach to the sides of the trailer or to another rail.

To use an embodiment of a sliding pin bracket system, a user could slide the sliding pin 36 through one of the main loops 16 of a sling 10 and through the apertures 34 in the beams 44 of a bracket 44, so that the sliding pin 36 holds the sling. The sling 10 may quickly be released by removing the pin retaining element and pulling on the handle 38 so that the sliding pin 36 slides out of the beams 44 of the bracket 32, releasing the main loop 16. This may allow the sling to be removed from the trailer even with the horse's weight bearing down on the sling.

In an embodiment, the auxiliary loops may offer greater stability for an animal in transport. There may be 2 auxiliary loops each in the front, center and rear of the sling. These loops may have several functions. The operator can either choose to not use them or in case of emergency and the animal is unable to remove themselves from the trailer. The auxiliary loops may be used to manually lift the animal out of the trailer or used with a belt system to provide additional stability while traveling. Pairs may be used in isolation. The front loops may reduce forward movement, and loops with a belt system would go around the chest of the animal. The center loops with a belt system may go over the back of the animal reducing vertical movement. The rear loops with a belt system may go around the rear legs and butt of the animal reducing backwards movement. The tightness of the belt system could be gauged by the owner/operator.

An embodiment of an equine safety sling for supporting a horse during transportation may include a plurality of nylon woven straps, sewn into an enclosed “H” design to form four corners; four main loops, a loop at each corner; and four auxiliary loops, a loop at each corner. The sling may be adapted to slide into four mounted posts in a horse trailer.

I claim:

1. A device for an animal having front and rear legs, comprising:
first and second outer straps, each outer strap having a front and rear end, thereby providing four ends;
a front inner strap that connects the outer straps so that the device supports the animal behind the front legs of the animal;
a rear inner strap that connects the outer straps so that the device supports the animal in front of the rear legs of the animal; and
a main loop at each of the four ends of the outer straps, adapted so that the device can be retained utilizing the main loops so as to secure the animal in place.

2. The device of claim 1, further comprising a plurality of auxiliary loops on the outer straps that can be accessed to further retain or maneuver the animal when the device is secured in place utilizing the main loops.

3. The device of claim 1 wherein the inner and outer straps are substantially nylon straps.

4. The device of claim 1 wherein the inner and outer straps are of sufficient strength, length, and width, so that the device can retain and support a horse for transport.

5. The device of claim 1, further comprising:
a sliding pin bracket system on the inside of an animal trailer, having at least four pins that slide through the main loops of the device, the pins located on the sides of the trailer or on rails within the trailer so that the pins retain the straps and the device retains the animal in place within the trailer.

6. The device of claim 1, further comprising:
a bracket having two aligned apertures; and
a pin that slides through the two apertures and through the main loop of one of the outer straps, thereby retaining said strap to the bracket.

7. The device of claim 1, further comprising:
a bracket having first and second generally parallel beams;
an aperture on each beam, the two apertures aligned so as to be generally collinear; and
a pin that slides through the first aperture, through one of the main loops of one of the outer straps, and then through the second aperture, so that the pin retains said outer strap to the bracket at a location between the apertures.

8. The device of claim 1, further comprising:
a bracket accessible from the inside of an animal trailer;
a pin that slides through the bracket and through the main loop of one of the outer straps;
a handle at a first end of the pin;
a retaining plate on the pin adjacent to the handle; and
an engageable retaining element at a second end of the pin;
wherein the retaining plate and retaining element cooperate to releasably retain the pin to the bracket.

9. A system to retain an animal, comprising:
a sling for the animal, having inner and outer straps that form an “H” shape, the sling having a loop at each of the outer four ends of the “H”; and
a plurality of retaining elements that engage with the loops so as to releasably retain the sling, thereby retaining the animal.

10. The system of claim 9, wherein each retaining element further comprises:
a bracket; and
a pin that slides through one of the loops and also through the bracket, so that the animal is retained when the pins are in place and the animal can be released when the pins are withdrawn.

11. The system of claim 9, wherein at least two retaining elements are located on a first side of a horse trailer, and at least two retaining elements are located on either a second side of the trailer or a rail within the trailer, so that a horse may be positioned between the two pairs of retaining elements and retained in place within the trailer by the sling.

12. The system of claim 9, wherein each retaining element further comprises:
a bracket accessible from the inside of an animal trailer, having first and second beams;
a pin that slides through apertures on the beams and through the main loop of one of the outer straps of the sling;
a handle at a first end of the pin;
a retaining plate on the pin adjacent to the handle; and
an engageable retaining element at a second end of the pin;
wherein the retaining plate and retaining element cooperate to releasably retain the pin to the bracket.

13. The system of claim 9, wherein the sling further comprises:
first and second outer straps, each outer strap having a front and rear end, thereby providing four ends;
a front inner strap that connects the outer straps so that the device supports the animal behind front legs of the animal;
a rear inner strap that connects the outer straps so that the device supports the animal in front of rear legs of the animal; and
a main loop at each of the four ends of the outer straps, adapted so that the device can be retained utilizing the main loops so as to secure the animal in place.

14. A method of supporting an animal during transportation, comprising:
providing a sling that includes two outer straps and two inner straps that connect the outer straps to form an enclosed H, the outer straps having a main loop at each of the four ends of the outer straps;
providing a trailer that includes four retaining elements;
loading the animal into the trailer;
attaching the main loops to the retaining elements so as to retain the animal in the trailer; and
transporting the animal;
wherein the sling supports the animal so as to help prevent the animal from falling during transportation.

15. The method of claim 14 wherein each retaining element further comprises:
a bracket accessible from the inside of the trailer, having first and second beams;
a pin that slides through apertures on the beams and through the main loop of one of the outer straps of the sling;
a handle at a first end of the pin;
a retaining plate on the pin adjacent to the handle; and
an engageable retaining element at a second end of the pin;
wherein the retaining plate and retaining element cooperate to releasably retain the pin to the bracket.

16. The method of claim 14 wherein the animal is a horse, the inner straps releasably support the horse between front and rear legs of the horse, and each retaining element is a sliding pin bracket system having pins retained by brackets, the method further comprising:
sliding the pins out of the brackets after transport, thereby releasing the horse; and
unloading the horse from the trailer.

17. The method of claim 14, further comprising:
positioning a first pair of the retaining elements on a first side of the trailer;
position a second pair of the retaining elements either on a second side of the trailer or on a rail within the trailer;
attaching a first pair of the main loops to the first pair of retaining elements so that the sling hangs down before loading the animal into the trailer; and
attaching a second pair of the main loops to the second pair of retaining elements so that the sling supports the animal.
